(19) United States
(12) Patent Application Publication
(10) Pub. No.: US 2009/0219976 A1
(43) Pub. Date: Sep. 3, 2009

(54) Transmission of Information to a GPS Device

(75) Inventors: Yair Oren, Washington, DC (US); Stanley B. Alterman, Jupiter, FL (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: MOBILEACCESS NETWORKS LTD.

(21) Appl. No.: 12/227,123

(22) PCT Filed: May 9, 2007
(86) PCT No.: PCT/US2007/011297

§ 371 Date: Feb. 25, 2009

Related U.S. Application Data
(60) Provisional application No. 60/799,477, filed on May 10, 2006.

(51) Int. Cl. H04B 1/707; G01S 1/00

(52) U.S. Cl. 375/141; 342/357.09; 375/E01.002

(57) ABSTRACT

A terrestrial system for transmitting non-GPS information for reception by a global positioning system (GPS) receiver, the system including a processor, a memory coupled to the processor and including computer-readable instructions configured to, when executed by the processor, cause the processor to receive the non-GPS information, determine an available pseudo-random noise (PRN) code, spread the non-GPS information using the available PRN code to provide a spread signal, modulate a GPS carrier frequency using the spread signal to produce a GPS compatible signal, and a terrestrial transmitter configured to transmit the GPS compatible signal.

### BACKGROUND

Global positioning system (GPS) receivers are widely used and have many potential applications. Many electronic devices now include GPS receivers such as mobile phones and in-car navigation systems. An electronic device containing a GPS receiver is capable of precisely determining the location (plus or minus a few centimeters) of the electronic device, anywhere in the world. Generally, using a GPS device, a user is able to obtain position information in terms of latitude, longitude, and altitude. The position information can then be processed into other forms of information, such as a location on a map or a Postal Code.

GPS receivers can use signals from a combination of satellite-based transmitters and ground-based transmitters to calculate the receiver's position. Referring to FIG. 1, orbiting the Earth is a constellation of twenty-four satellites 5 in six planes 10. Each of the satellites transmits signals modulated by a pseudo-random noise (PRN) code towards the Earth's surface. A unique PRN code (also known as a “gold code”) is assigned to each GPS satellite 5. with several spare PRN codes available. The signals can carry information that includes a coarse/acquisition code, a precision code (P-code), and a navigation message. GPS receivers calculate location information using the signals and information from at least three of the GPS satellites 5. By comparing the amount of time that it took for the signal transmitted by each satellite to reach the GPS receiver, and using the data contained in the signals, the GPS receiver is able to precisely calculate the location of the GPS receiver. The ground-based transmitters can monitor the GPS signals, and correct for any drift in the orbits of the GPS satellites 5 by updating the ephemeris constant and/or the base clock offset of each of these satellites 5. In this manner, a user can use a GPS receiver to precisely determine the location of the GPS receiver.

The GPS satellites 5 transmit signals over several frequencies such as the L1 carrier frequency (1575.42 MHz) and the L2 carrier frequency (1227.6 MHz), and in the future, the L5 carrier frequency (1176.45 MHz). The GPS satellites 5 use Direct Sequence Spread Spectrum (DSSS) modulation, which is a type of code-division multiple-access (CDMA) modulation, to modulate the signals transmitted by each of the GPS satellites 5. The signals transmitted by each of the GPS satellites 5 (e.g., the P-code, the coarse/acquisition signal, etc.) are “spread” by the PRN code corresponding to an individual satellite. The spread signal is used to modulate a carrier frequency (e.g., the L1 and/or L2 frequencies). The modulated spread signal is broadcast to GPS receivers. The use of DSSS can increase the signal's resistance to interference. Since each signal is nearly uncorrelated with respect to each other, the DSSS modulated GPS signals can be demodulated using standard CDMA techniques.

The navigation message is a 50 Hz signal that includes data bits describing the GPS satellite orbits, clock corrections, and other system parameters. A complete navigation message is sent over the course of a 12.5-minute cycle using twenty-five 1500-bit frames. A single 1500-bit frame is sent every thirty seconds (yielding an effective throughput of 50 bps). Each 1500-bit frame is divided into five 300-bit sub-frames. The first sub-frame of each 1500-bit frame includes satellite-specific clock-correction information. The second and third sub-frames include satellite-specific ephemeris data information. The fourth and fifth sub-frames include system data, or almanac data. Combining twenty-five consecutive corresponding sub-frames (e.g., twenty-five consecutive fourth sub-frames, twenty-five consecutive fifth sub-frames, etc.) yields an entire navigation message.

The signals transmitted by the GPS satellites 5 travel line of sight, but can have a hard time passing through solid objects such as building structures and mountains. For example, if a user has a GPS receiver inside of a 50-story building, the user may not be able to receive any GPS satellite signals. The lack of a GPS satellite signal can have disastrous consequences such as an inability for 911 call centers to locate a caller.

The Federal Communications Commission (FCC) has established a wireless Enhanced 911 (“E911”) plan. The E911 program is divided into two parts—Phase I and Phase II. Phase I requires wireless carriers to report the telephone number of a wireless 911 caller and the location of the carrier's antenna that received the call. Phase II of the E911 regulations require wireless carriers to provide far more precise location information, within 50 to 300 meters in most cases. To comply with the wireless E911 plan, many wireless carriers have integrated GPS receivers into mobile phones, and other mobile communication devices. In the event of a 911 call by a mobile phone user, the GPS enabled mobile phone can relay location information provided by the GPS receiver to a 911 call center for use in determining the location of the mobile phone.

### SUMMARY

In general, in an aspect, the invention provides a terrestrial system for transmitting non-GPS information for reception by a GPS receiver, the system including a processor, a memory coupled to the processor and including computer-readable instructions configured to, when executed by the processor, cause the processor to receive the non-GPS information, determine an available PRN code, spread the non-GPS information using the available PRN code to provide a spread signal, modulate a GPS carrier frequency using the spread signal to produce a GPS compatible signal, and a terrestrial transmitter configured to transmit the GPS compatible signal.

Embodiments of the invention may provide one or more of the following features. The GPS carrier frequency is at least one of the L1, L2, and L5 carrier frequencies. The terrestrial transmitter re-transmits existing GPS signals. The transmitter is disposed within a building in a location where existing GPS signals cannot be received. The non-GPS information includes E911 information. The terrestrial transmitter is configured to transmit the GPS compatible signal using a duty cycle of substantially 10-30%.

In general, in another aspect, the invention provides a terrestrial system for transmitting non-GPS information for reception by a GPS receiver, the system including an input module configured to receive the non-GPS information, a processor coupled to the input module, the processor being configured to determine an available PRN code and to produce a GPS compatible signal that is generated as a function of the available PRN code, the GPS compatible signal including a navigation message, the navigation message including the non-GPS information, an amplifier coupled to the processor and configured to amplify the GPS compatible signal, and a terrestrial transmitter coupled to the processor and configured to transmit the GPS compatible signal.

Embodiments of the invention may provide one or more of the following features. The non-GPS information is transmitted using a series of frames of consecutive navigation messages. The processor is configured to generate a plurality of GPS compatible signals, each generated as a function of a different available PRN code.

The terrestrial transmitter is configured to transmit the GPS compatible signal using a duty cycle of substantially 10-30%.

In general, in another aspect, the invention provides a method of terrestrially transmitting non-GPS information for reception by a GPS receiver, the method including receiving non-GPS information, determining an available PRN code, spreading the non-GPS information using the available PRN code to produce a spread signal, modulating a GPS carrier frequency using the spread signal to produce a GPS compatible signal, and transmitting the GPS compatible signal using a terrestrial transmitter.

Embodiments of the invention may provide the following feature. Transmitting the GPS compatible signal includes transmitting the GPS compatible signal using a duty cycle of substantially 10-30%.

In general, in another aspect, the invention provides a system including a transmitter including a first processor configured to receive non-GPS information and to encode the non-GPS information in a navigation message of a GPS signal to produce a GPS compatible signal, wherein an available PRN code is used to encode the non-GPS information, a terrestrial transmitter configured to transmit the GPS compatible signal, a GPS receiver including an antenna configured to receive GPS signals including the GPS compatible signal, a second processor coupled to the antenna and configured to receive the GPS compatible signal from the antenna, the second processor being configured to recognize the presence of the non-GPS information in the GPS compatible signal and to process the GPS compatible signal in a predetermined manner.

Embodiments of the invention may provide one or more of the following features. The first processor is configured to encode the non-GPS information using an available PRN code. The second processor is configured parse the navigation message to retrieve the non-GPS information. The first processor is configured to produce a plurality of GPS compatible signals each encoded using a different available PRN code. The second processor is configured to parse a plurality of GPS compatible signals according to the available PRN code used to encode the non-GPS information. The non-GPS information is used by the receiver for providing location-based services.

Various aspects of the invention can provide one or more of the following capabilities. Virtually any type of information can be transmitted to GPS receivers using the existing GPS infrastructure. Information can be transmitted to GPS receivers (e.g., a device with an antenna, a radio receiver that can receive GPS signals and information, and a processor for use the worldwide GPS system) using the navigation message of a GPS signal. Information can be transmitted to GPS receivers using a terrestrial GPS transmitter such as a pseudolite (e.g., a terrestrial transmitter that can provide services typically provided by a satellite such as a GPS signal). Location-based services can be provided to GPS receivers. Location-based advertising can be provided to GPS receivers. Communication and reprogramming of electronic devices coupled to a GPS receiver can be accomplished.

Standard GPS receivers can continue to operate successfully even in the presence of information signals containing supplemental information. A transmission source can utilize signal PRN codes which are unused either in the entire GPS satellite constellation or at least with respect to the “visible” satellites at the time of the transmission. Information can be addressed to a specific GPS receiver. Information can be provided to an electronic device having no communication capability apart from an attached GPS receiver device, without redesigning the electronic device. Information can be provided to a GPS receiver using a non-interfering duty-cycle, for example, a duty cycle that is less than about 30% of existing GPS satellite transmissions. Information can be provided to a GPS receiver by modulating the information using an orthogonal code different from any of the GPS satellites 5. Existing GPS receivers and attached electronic devices can be reprogrammed using information transmitted in a GPS signal.

### BRIEF DESCRIPTION OF THE DRAWINGS

FIG. 1 is a schematic diagram of a constellation of GPS satellites.

FIG. 2 is a schematic diagram of a GPS system including terrestrial transmitters.

FIG. 3 is a schematic diagram of a portion of a navigation message included in a GPS signal.

FIG. 4 is a flowchart of a process for transmitting and receiving information using the system shown in FIG. 2.

FIG. 5 is a flowchart of a process for transmitting and receiving information using the system shown in FIG. 2.

FIG. 6 is a schematic diagram of an implementation of a GPS system using terrestrial transmitters.

FIG. 7 is a schematic diagram of a mobile communication device.

FIG. 8 is a schematic diagram of a waveform related to the principal of orthogonality.

### DETAILED DESCRIPTION

Embodiments of the invention provide techniques for transmitting information, such as data, to a GPS receiver device without substantially interfering with standard GPS satellite signals. GPS receiver devices include electronic devices with the capability to receive GPS satellite signals, such as GPS-enabled mobile phones, in-vehicle navigation systems, aviation navigation systems, maritime navigation systems, etc. A transmission source transmits information to a GPS receiver using GPS-like signals. The information can be transmitted to a GPS receiver, for example, using signals with a lower (or complementary) duty-cycle than existing GPS signals and/or by modulating the signal using available PRN codes (for example, one of the spare or unused PRN codes). Depending on the chosen transmission method, the GPS receiver can use CDMA demodulation techniques to demodulate and extract the information contained in the GPS-like signals broadcast to the GPS receiver.

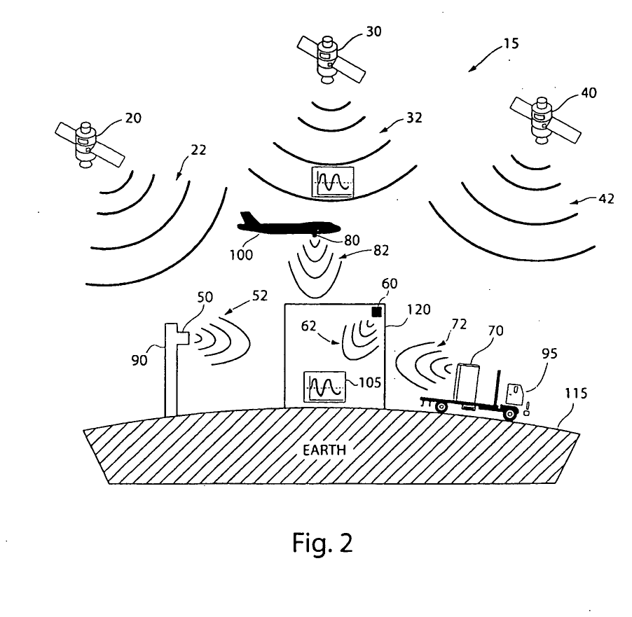

Referring to FIG. 2 a GPS system 15 includes the GPS satellites 5 (here, satellites 20, 30, and 40), transmitters 50, 60, 70, and 80, signals 22, 32, 42, 52, 62, 72, and 82, a land platform 90, a mobile platform 95, and a GPS receiver 105. The satellites 20, 30, and 40 transmit the GPS signals 22, 32, and 42 towards Earth 115 for reception by the GPS receiver 105. Supplemental “GPS-like” signals, such as signals 52, 62, 72, and 82, can be used to broadcast GPS information and/or other information to GPS receivers. Other quantities of the transmitters 50, 60, 70, and 80, the satellites 20, 30, and 40, and/or the GPS receiver 105 are possible (e.g., five satellites, one ground-based transmitter, and four GPS receivers).

The transmitters 50, 60, 70, and 80 can be used to provide GPS signals and/or GPS-like signals to the GPS receiver 105. Non-satellite transmitters (i.e., terrestrial transmitters) can be stationary, mobile, and/or airborne. For example, the transmitter 50 is installed on the land platform 90, the transmitter 60 is installed within a building 120, and the transmitter 70 is installed on the mobile platform 95 (in FIG. 2, a truck). The land platform 90 can be a stationary object such as a pole dedicated to the transmitter 50 or another structure such as a radio antenna, a mobile-phone tower, a light pole, a roof of a building, a water tower, a bridge, a mountain top, etc. The mobile platform 95 can be a moving object, such as a car, a truck, a boat, a train, a bus, a tank, etc. The transmitter 80 is installed on an airplane, although other similar aerial vehicles can be used (e.g., a helicopter, an unmanned aerial vehicle (UAV), and/or a blimp).

Non-satellite based transmitters (e.g., the transmitters 50, 60, 70, and 80) can be used to supplement (e.g., repeat) the GPS signals transmitted by the GPS satellites 5, and/or to send GPS-like. signals, including non-GPS information, to the GPS receiver 105. Non-GPS information is, for example, information that is not used by the GPS receiver to determine location. The kinds of non-GPS information that can be broadcast to the GPS receiver 105 (or any GPS enabled device) is broad. For example, the information can include information such as advertisements, coupons, location information, text messages, image files, audio files, video files, reconfiguration instructions, firmware upgrades, encrypted signals, software updates, anti-virus updates, Web pages, music files, movie files, navigation information, navigation files, e-mails, map files, document files, etc. For example, navigation information contained in the GPS signals transmitted by the GPS satellites 5 can be used to guide vehicles such as commercial airliners, boats, and automobiles. Transmissions of other types of information are also possible.

Information can be sent to a GPS receiver 105 using standard GPS signal formats such as the navigation message embedded in the GPS signals 22, 32, 42, 52, 62, 72, and 82. The navigation message can be replaced with other information, which can result in a bandwidth of approximately 50 bits-per-second (bps). Other data rates are possible. Other portions of a standard GPS signal can be replaced with other information. More than one of the unused PRN codes can be used to transmit data.

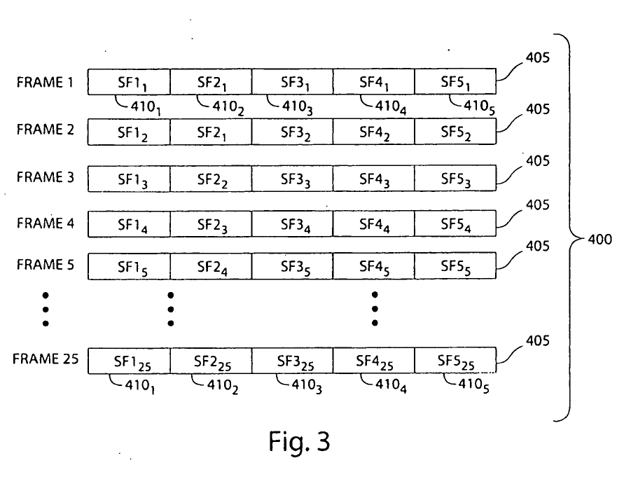

Referring also to FIG. 3, a navigation message 400 includes frames 405 and sub-frames 410₁ through 410₅. Twenty-five of the frames 405 make up a single navigation message 400, although other quantities of frames 405 can make up an entire navigation message 400 (e.g., 50 of the frames 405 can make up a single navigation message 400). Each of the frames 405 includes five sub-frames 410₁ through 410₅, although other quantities of sub-frames 410 can make up a single one of the frames 405 (e.g., ten sub-frames can make up a single one of the frames 405).

The information can be a single 50 bit payload which is sent in a single one of the sub-frames 410, or can be a larger message that is split up over multiple sub-frames 410 or multiple navigation messages sent on the same or multiple PRN codes. For example, a 2000-bit message can be split up over forty consecutive sub-frames 410. The 2000-bit message could be split up over forty consecutive corresponding sub-frames (e.g., forty consecutive 410₂ sub-frames). Other combinations are possible. The GPS receiver can reconstruct information that has been split up over multiple sub-frames, or alternatively a processor located externally to the GPS receiver can reconstruct information split up over multiple sub-frames 410.

The information transmitted by the non-satellite based transmitters can be broadcast using existing GPS frequencies such as the L1 and L2 bands, and in the future, the L5 band, although other frequency bands can be used. Because the GPS satellites 5 can transmit on the same frequency bands as the transmitters 50, 60, 70, and 80, the signals transmitted by the transmitters 50, 60, 70, and 80 can interfere with existing GPS signals. To reduce, or even eliminate interference, information can be broadcast to GPS receivers (e.g., the GPS receiver 105) using an available PRN code to encode the information and/or using different or lower duty-cycle transmissions. Varying the duty-cycle of the transmissions (e.g., using a duty cycle of 10-30%) can reduce interference with existing GPS signals by improving the signal-to-noise ratio of the information transmitted relative to existing GPS signals. Other techniques can be used.

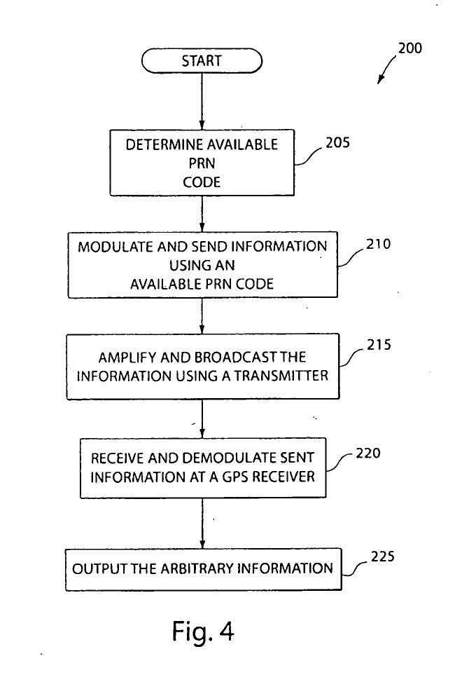

In operation, referring to FIG. 4, with further reference to FIG. 2, a process 200 for transmitting information using an available PRN code and the GPS system 15 includes the stages shown. The process 200, however, is exemplary only and not limiting. The process 200 can be altered, e.g., by having stages added, removed, or rearranged.

At stage 205 an available PRN code is identified. An available PRN code is a PRN code such as one of the spare PRN codes and/or a PRN code in use by a GPS satellite 5 that is out of view of the GPS receiver 105. If one of the spare PRN codes is chosen, the likelihood of interference with another of the GPS satellites 5 can be reduced or even eliminated. Alternatively, a tracking module (e.g., a computer processor running the necessary software) can track the GPS satellites 5 to determine which of the satellites 5 are “in-view” of the GPS receiver 105 at any given time. The tracking module can select a PRN code corresponding to one of the GPS satellites 5 that is not in-view of the GPS receiver 105 to modulate the information being broadcast by the transmitters 50, 60, 70, and/or 80. As the GPS satellites 5 orbit the Earth 115, the availability of a particular PRN code can change. For example, in FIG. 2, the GPS satellite 30 (here, acting as one of the GPS satellites 5) is shown in-view of the GPS receiver 105 making its code unavailable for use in the DSSS modulation process. As the satellite 30 orbits the Earth 115, the satellite 30 can disappear over a horizon of the Earth 115, which can make its PRN code available for by a ground based transmitter. Once the satellite 30 is again in-view of the GPS receiver, however, its PRN code becomes unavailable. The tracking module can track and/or predict which PRN code will be available at any given time.

At stage 210, the information can be sent using DSSS and the selected available PRN code. For example, the information is spread by the available PRN code to provide a spread signal, which is used to module a GPS carrier frequency (e.g., the L1, L2, and/or L5 carrier frequencies). Portions of the information can be sent using one or more of the available PRN codes. For example, multiple information streams can be sent using different PRN codes, or a single information stream can be split into multiple streams that are sent using different PRN codes.

At stage 215, the sent information can be amplified and broadcast by a transmitter (e.g., the satellites 20, 30, and/or 40, and/or the transmitters 50, 60, 70, and/or 80) for reception by a GPS receiver (e.g., the GPS receiver 105). When the GPS satellites 5 are used to broadcast non-GPS signals, cooperation by the entity operating the satellite (e.g., the United States Government) may be required.

At stage 220, the sent information can be received and amplified by a GPS receiver (e.g., the GPS receiver 105). The transmitted information can be demodulated to substantially recover the sent information. Error correction, such as a cyclic redundancy check (CRC) code with error correction capability, can be used during transmission process. At stage 225 the recovered information is output by the GPS receiver.

The stages 220 and/or 225 (including sub-portions of the stages 220 and/or 225) can be accomplished by a GPS receiver (e.g., the GPS receiver 105), or another device external to the GPS receiver. For example, the GPS receiver 105 itself can demodulate the modulated sent information. Alternatively, the GPS receiver 105 (for example, a GPS receiver in a mobile phone) can receive the information stream and retransmit it via a wireless phone network to a remote processor, such as one operated by mobile phone network operator. The remote processor can then demodulate the sent information and transmit the recovered information to the GPS receiver 105 and/or the attached mobile phone.

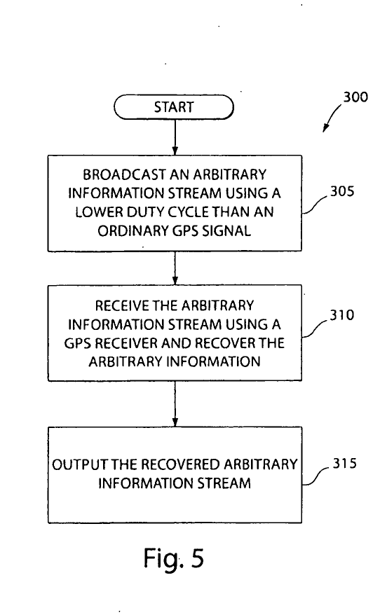

In operation, referring to FIG. 5, with further reference to FIG. 2, a process 300 for transmitting information using reduced duty-cycles and/or non-interfering duty-cycles, or PRN codes, using the GPS system 15 includes the stages shown. The process 300, however, is exemplary only and not limiting. The process 300 can be altered, e.g., by having stages added, removed, or rearranged. While the process 300 describes the process of transmitting information, the process 300 can also be used to transmit standard GPS signals.

At stage 305, a transmitter (e.g., the satellites 20,30, and/or 40, and/or the transmitters 50, 60, 70, and/or 80) broadcasts the information stream using a duty cycle of about 10-30%. Other duty cycles can be used. The information stream is a modified navigation message, as described above, although other forms of the information stream are possible. Broadcasting information using a lower duty cycle than standard GPS signals can reduce, or possibly eliminate interference with standard GPS signals. The information stream is encoded using an existing PRN code. The PRN code used to encode the information stream can be a PRN code in-use by a GPS satellite for transmitting GPS signals, although unused PRN codes can be used in addition to or instead of the in-use PRN code. The encoded information stream can be broadcast at a power level higher than existing GPS signals, subject to saturation effects in the GPS transmitter and/or receiver.

At stage 310, a GPS receiver (e.g., the GPS receiver 105) receives the lower duty-cycle broadcast. The GPS receiver can be configured to detect, receive, and/or process the lower duty-cycle broadcast to recover the information contained therein. For example, correlation and integration can be used to recover the lower duty-cycle broadcast when the signal strength is below the noise floor. The GPS receiver processes the lower-duty cycle information stream such that simultaneous detection of existing GPS signals is possible. At stage 315, the GPS receiver outputs the recovered information using standard GPS spread spectrum processing (as described herein).

The stages 310 and/or 315 can be accomplished by a GPS receiver (e.g., the GPS receiver 105), or another device external to the GPS receiver. For example, the GPS receiver 105 can be configured to process the lower duty-cycle broadcast to recover the information. Alternatively, the GPS receiver can receive the lower-duty cycle broadcast and retransmit it to a remote processor using, for example, cellular transmission technology. The remote processor can process the received broadcast to recover the information, and transmit the recovered information to the GPS receiver 105 and/or the attached mobile phone.

The GPS system 15 of FIG. 2 can be used to provide information to GPS receivers (here, the GPS receiver 105). When the GPS receiver is able to receive standard GPS signals, the GPS system 15 can be used to augment the standard GPS signals by providing information to the GPS receiver 105. Alternatively, in locations where the GPS receiver 105 is unable to receive standard GPS signals (e.g., within a building or a cave), the GPS system 15 can be used to relay the standard GPS signals and/or provide other information to the GPS receiver 105.

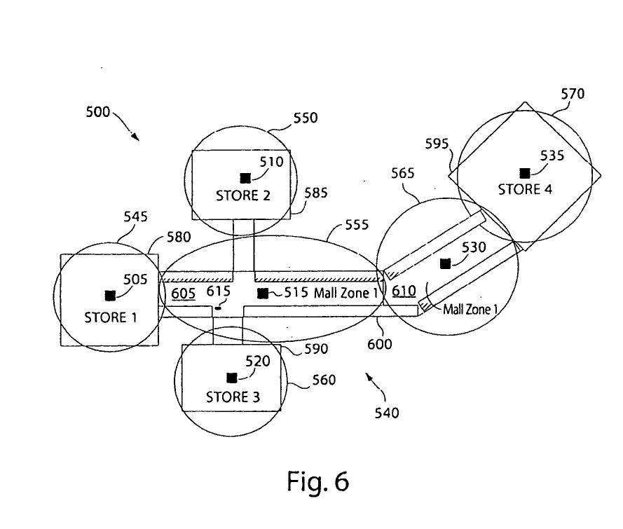

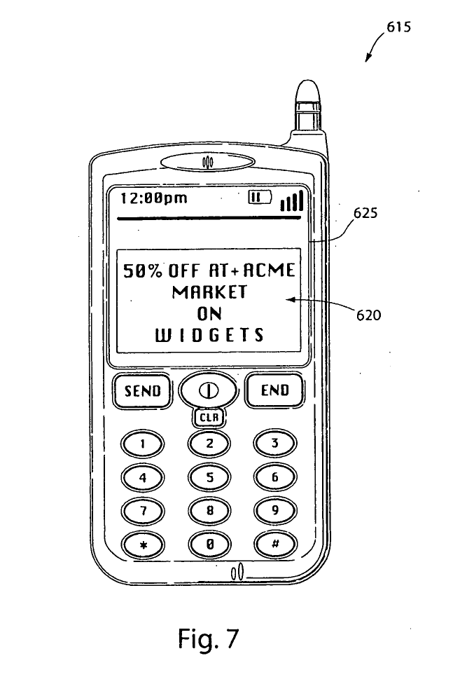

Referring also to FIGS. 6 and 7, a system 500 includes the transmitters 505, 510, 515, 520, 525, and 530, although other quantities of transmitters are possible. The system 500 can be used in and/or around a structure 540 to establish multiple zones 545, 550, 555, 560, 565, and 570. In FIG. 6, for example, the structure 540 is a mall including anchor stores 580, 585, 590, and 595, and tenant portion 600. Each of the zones 545, 550, 555, 560, 565, and 570 includes at least one of the transmitters 505, 510, 515, 520, 525, and 530. The transmitters 505, 510, 520, and 535 are located in the anchor stores 580, 585, 590, and 595, respectively. The transmitters 515 and 530 are located in portions 605 and 610 of the tenant portion 600, respectively. Each of the transmitters 505, 510, 515, 520, 525, and 530 can be configured to transmit a message that is pertinent to the location of a person using the GPS receiver such as a GPS enabled mobile phone 615. While the structure 540 is described as a mall, the structure 540 can be another type of facility such as an office building, a manufacturing plant, a storage facility, a park, a racetrack, a stadium, etc.

The transmitters 505, 510, 515, 520, 525, and 530 are pseudolites, such as the transmitter 60, which are mounted in various parts of the structure 540 to broadcast signals to GPS receivers (here, a GPS enabled mobile phone 615). Each of the transmitters located in each of the zones 545, 550, 555, 560, 565, and 570 can broadcast a unique set of information to GPS receivers located within each respective zone. For example, each of the transmitters 505, 510, 515, 520, 525, and 530 can broadcast a different set of information to GPS receivers located in each of the zones 505, 510, 515, 520, 525, and 530, respectively. The information can be broadcast to the GPS enabled mobile phone using, for example, the process 200 and/or 300.

Other configurations of the system 500 are possible. For example, while each of the zones 545, 550, 555, 560, 565, and 570 are shown as substantially circular, other dispersion patterns are possible (e.g., using different transmitter configurations). While the transmitters 505, 510, 515, 520, 525, and 530 are shown as being attached to the structure 540, other configurations are possible. For example, the transmitters 505, 510, 515, 520, 525, and 530 can be mounted on a pole (e.g., transmitter 50, on a vehicle (e.g., transmitter 70), and/or on an air vehicle (e.g., the transmitter 80).

The system 500 can be used to help comply with the E911 plan. For example, the GPS enabled mobile phone 615, may have problems receiving the standard GPS signals from the GPS satellites 5 while located within the structure 540. When the GPS enabled mobile phone 615 is unable to receive standard GPS signals from the GPS satellites 5, the GPS enabled mobile phone 615 can have problems providing location information to a 911 call center as required by Phase II of the E911 plan. The mobile phone 615, however, can be configured to receive GPS signal from a GPS satellite (e.g., the GPS satellites 5) that is retransmitted by the system 500 within the structure 540. For example, a user with the GPS enabled mobile phone 615 may have trouble receiving GPS signals within the structure 540. If the GPS enabled mobile phone 615 is unable to receive updated location information (e.g., GPS information), the GPS enabled mobile phone 615 can have problems relaying the caller's position to the 911 operations center during a call to 911. Each of the transmitters 505, 510, 515, 520, 525, and 530 can transmit information including location information (e.g., an address where the caller is located), which can be relayed to the 911 operations center. Even if the GPS enabled mobile phone 615 is able to receive the standard GPS signals, additional location information can be transmitted to the GPS enabled mobile phone 615 to augment the standard GPS information. For example, Phase II of the E911 rules require that location information transmitted to a 911 operations center be accurate to within 50-300 meters. Thus, in the Mall 600, additional location information can include store name or mall area, or in a tall building (e.g., 80-stories), additional location information can supply which floor the caller is on, to help satisfy the E911 rules.

The system 500 can be used to provide location-based services by transmitting information to GPS receivers (e.g., the GPS enabled mobile phone 615) located within each of the zones 545, 550, 555, 560, 565, and 570. For example, management of the anchor store 580 can choose to broadcast a coupon or advertisement (in FIG. 7, text 620) relating to products or services offered by the anchor store 580 to a customer's GPS enabled mobile phone 615 located within the zone 545 (which corresponds to the location of the anchor store 580). The text 620 can be displayed on a display 625 of the GPS enabled mobile phone 615. Alternatively, the information can be used to attract potential customers by, for example, broadcasting an advertisement relating to the anchor store 585 to the GPS enabled mobile phone 615 of a person located outside of the store 585 (e.g., in portion 605 of the tenant portion 600.)

Other configurations of the transmitters 505, 510, 515, 520, 525, and 530 and the zones 545, 550, 555, 560, 565, and 570 are possible. For example, while the zones 545, 550, 555, 560, 565, and 570 are shown in FIG. 6 as substantially distinct areas of the structure 540, each of the zones 545, 550, 555, 560, 565, and 570 can overlap, partially or totally, to transmit multiple information streams to GPS receivers.

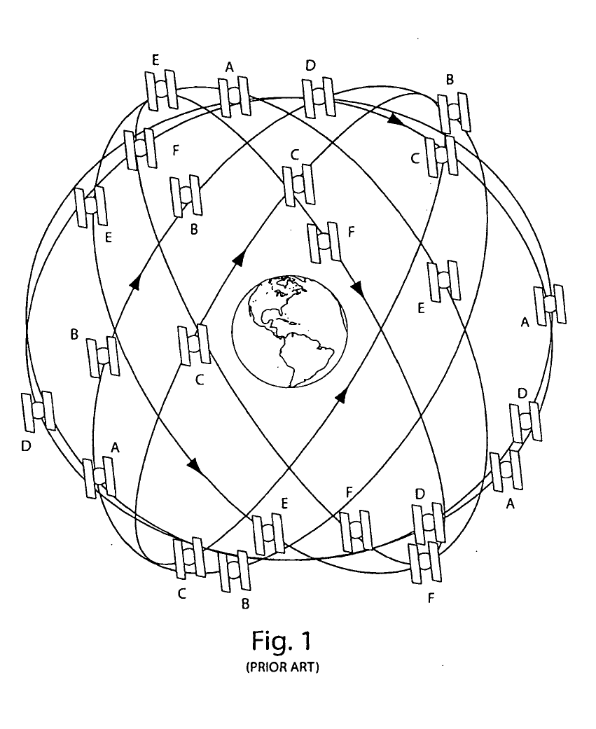

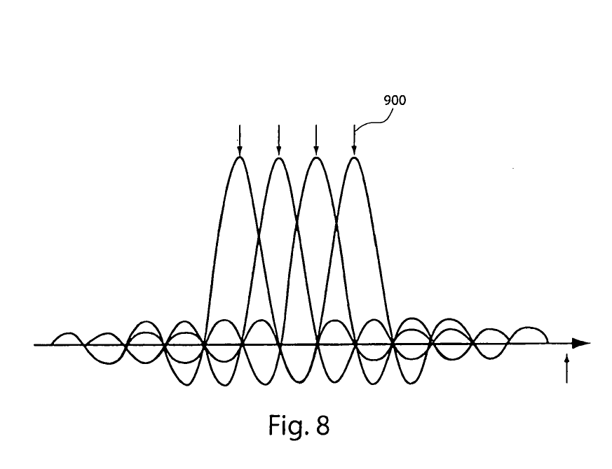

Other embodiments are within the scope of the invention. For example, due to the nature of software, functions described above can be implemented using software, hardware, firmware, hardwiring, or combinations of any of these. Features implementing functions can also be physically located at various positions, including being distributed such that portions of functions are implemented at different physical locations. While FIG. 1 has been described in context of a single GPS receiver (i.e., the GPS receiver 105), other quantities are possible. The GPS satellites 20, 30, and 40 can be configured to transmit other information. The GPS receivers 105 can require upgrades/updates to use the method and systems described herein, such as software updates, firmware updates, hardware updates, etc. The PRN codes used to modulate the information can be totally orthogonal, or partially orthogonal. When two carrier frequencies are totally orthogonal to one another, the frequencies are chosen such that a receiver can reject an unwanted interfering signal, regardless of the intensity of the interfering signal. For example, when multiple modulation frequencies are used, each frequency overlaps with surrounding frequencies. When the signals are orthogonal, however, the points at which a desired frequency is measured, all other frequencies are zero (e.g., arrow 900 in FIG. 8). The L1 band and/or the L5 band is preferably used for “life-critical” information (e.g., navigation information provided to a commercial airliner), although other frequency bands can be used. While some signals have been described as “GPS-like,” other formats are possible. For example, the navigation message format of a standard GPS signal can be replaced by another message format.

Further, while the description above refers to the invention, the description may include more than one invention.

What is claimed is:

1. A terrestrial system for transmitting non-GPS information for reception by a global positioning system (GPS) receiver, the system comprising:
a processor;
a memory coupled to the processor and including computer-readable instructions configured to, when executed by the processor, cause the processor to:
receive the non-GPS information;
determine an available pseudo-random noise (PRN) code;
spread the non-GPS information using the available PRN code to provide a spread signal;
modulate a GPS carrier frequency using the spread signal to produce a GPS compatible signal; and
a terrestrial transmitter configured to transmit the GPS compatible signal.

2. The system of claim 1 wherein GPS carrier frequency is at least one of the L1, L2, and L5 carrier frequencies.

3. The system of claim 1 wherein the terrestrial transmitter re-transmits existing GPS signals.

4. The system of claim 1 wherein the transmitter is disposed within a building in a location where existing GPS signals cannot be received.

5. The system of claim 1 wherein the non-GPS information includes E911 information.

6. The system of claim 1 wherein the terrestrial transmitter is configured to transmit the GPS compatible signal using a duty cycle of substantially 10-30%.

7. A terrestrial system for transmitting non-GPS information for reception by a global positioning system (GPS) receiver, the system comprising:
an input module configured to receive the non-GPS information;
a processor coupled to the input module, the processor being configured to determine an available pseudo-random noise (PRN) code and to produce a GPS compatible signal that is generated as a function of the available PRN code, the GPS compatible signal including a navigation message, the navigation message including the non-GPS information;
an amplifier coupled to the processor and configured to amplify the GPS compatible signal; and
a terrestrial transmitter coupled to the processor and configured to transmit the GPS compatible signal.

8. The system of claim 7 wherein the non-GPS information is transmitted using a series of frames of consecutive navigation messages.

9. The system of claim 7 where in the processor is configured to generate a plurality of GPS compatible signals, each generated as a function of a different available PRN code.

10. The system of claim 7 wherein the terrestrial transmitter is configured to transmit the GPS compatible signal using a duty cycle of substantially 10-30%.

11. A method of terrestrially transmitting non-GPS information for reception by a global positioning system (GPS) receiver, the method comprising:
receiving non-GPS information;
determining an available pseudo-random noise (PRN) code;
spreading the non-GPS information using the available PRN code to produce a spread signal;
modulating a GPS carrier frequency using the spread signal to produce a GPS compatible signal; and
transmitting the GPS compatible signal using a terrestrial transmitter.

12. The method of claim 11 wherein transmitting the GPS compatible signal includes transmitting the GPS compatible signal using a duty cycle of substantially 10-30%.

13. A system comprising:
a transmitter comprising:
a first processor configured to receive non-GPS information and to encode the non-GPS information in a navigation message of a global positioning system (GPS) signal to produce a GPS compatible signal, wherein an available pseudo-random noise (PRN) code is used to encode the non-GPS information;
a terrestrial transmitter configured to transmit the GPS compatible signal;
a GPS receiver comprising:
an antenna configured to receive GPS signals including the GPS compatible signal;
a second processor coupled to the antenna and configured to receive the GPS compatible signal from the antenna, the second processor being configured to recognize the presence of the non-GPS information in the GPS compatible signal and to process the GPS compatible signal in a predetermined manner.

14. The system of claim 13 wherein the first processor is configured to encode the non-GPS information using an available pseudo-random noise (PRN) code.

15. The system of claim 13 wherein the second processor is configured parse the navigation message to retrieve the non-GPS information.

16. The system of claim 13 wherein the first processor is configured to produce a plurality of GPS compatible signals each encoded using a different available PRN code.

17. The system of claim 16 wherein the second processor is configured to parse a plurality of GPS compatible signals according to the available PRN code used to encode the non-GPS information.

18. The system of claim 16 wherein the non-GPS information is used by the receiver for providing location-based services.
